(19) United States
(12) Patent Application Publication
(10) Pub. No.: US 2018/0257499 A1
(43) Pub. Date: Sep. 13, 2018

(54) DUAL CHARGING STATION

(71) Applicant: Faraday&Future Inc., Gardena, CA (US)

(72) Inventor: Omourtag Alexandrov Velev, La Crescenta, CA (US)

(21) Appl. No.: 15/713,527

(22) Filed: Sep. 22, 2017

Related U.S. Application Data
(60) Provisional application No. 62/398,850, filed on Sep. 23, 2016.

(51) Int. Cl. B60L 11/18; C25B 1/04; C25B 9/06

(52) U.S. Cl. CPC B60L 11/1824; B60L 11/1816; C25B 9/06; C25B 1/04; B60L 11/1881

(57) ABSTRACT

A dual charging system is disclosed. The system may comprise a receiver configured to receive power, an electrical charger port coupled to the receiver for charging a vehicle, a rechargeable battery coupled to the receiver and the electrical charger port, a fuel generator coupled to the receiver, and a switch coupled to the receiver, the electrical charger port, rechargeable battery, and fuel generator. The switch may be configured to switch the received power from the receiver to at least one of the rechargeable battery, the fuel generator, or the electrical charger port.

### CROSS-REFERENCE TO RELATED APPLICATIONS

This application claims the benefit of U.S. Provisional Application No. 62/398,850, filed Sep. 23, 2016, the entirety of which is hereby incorporated by reference.

### TECHNICAL FIELD

The present disclosure relates generally to dual charging station systems and methods, and more particularly, to electric-fuel cell charging station systems and methods.

### BACKGROUND

Electric vehicles (EVs) and fuel cell vehicles are considered energy-efficient replacements for existing petroleum-powered vehicles. As a part of the supporting infrastructure, individual charging stations have been built to charge the EVs and fuel cell vehicles. However, power processing equipment utilization has not been optimized with respect to such charging stations. For example, EV charging stations are more frequently used during day time than night time, during which EV owners may often choose to charge their cars at home. As a result, the electricity drawn from the grid to the EV charging stations may be hardly used during night. Further, a significant price portion for recharging fuel cell vehicles comes from the transportation cost of compressed hydrogen from production sites to fuel cell charging stations. Therefore, it is desirable to improve the overall energy efficiency of clean-energy vehicle charging infrastructures and to reduce the maintenance cost for these vehicles.

### SUMMARY

One aspect of the present disclosure is directed to a dual charging system. The system may comprise a receiver configured to receive power, an electrical charger port coupled to the receiver for charging a vehicle, a rechargeable battery coupled to the receiver and the electrical charger port for storing energy when the charger port is not in use, a fuel generator coupled to the receiver, and a switch coupled to the receiver, the electrical charger port, rechargeable battery, and fuel generator. The switch may be configured to switch the received power from the receiver to at least one of the rechargeable battery, the fuel generator, or the electrical charger port.

Another aspect of the present disclosure is directed to a dual charging system. The system may comprise a receiver configured to receive power, a fuel generator coupled to the receiver, an electrical charger port coupled to the receiver, and a switch configured to switch the received power to the electrical charger port during a first time period and switch the received power to the fuel generator during a second time period.

Another aspect of the present disclosure is directed to a dual charging method. The method may comprise receiving power at a receiver, and switching the received power from the receiver to at least one of a rechargeable battery, a fuel generator, or an electrical charger port. The electrical charger port may couple to the receiver for charging a vehicle. The rechargeable battery may couple to the receiver and the electrical charger port. The fuel generator may couple to the receiver. The switch may couple to the receiver, the electrical charger port, the rechargeable battery, and the fuel generator.

Another aspect of the present disclosure is directed to a dual charging method. The method may comprise receiving power by a receiver, switching the received power to an electrical charger port coupled to the receiver during a first time period, and switching the received power to a fuel generator coupled to the receiver during a second time period.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a block diagram illustrating a dual charging station system, consistent with exemplary embodiments of the present disclosure.

FIG. 2 is a flow diagram illustrating method for dual charging, consistent with exemplary embodiments of the present disclosure.

FIG. 3 is a flow diagram illustrating method for dual charging, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Existing EV and fuel cell charging stations function independently and are not energy and power processing usage-optimized. The disclosed systems may mitigate or overcome one or more of the problems set forth above and/or other problems in the prior art. For example, the disclosed systems can improve overall power processing equipment usage of the clean-energy vehicle charging system and thus reduce overall recharging cost.

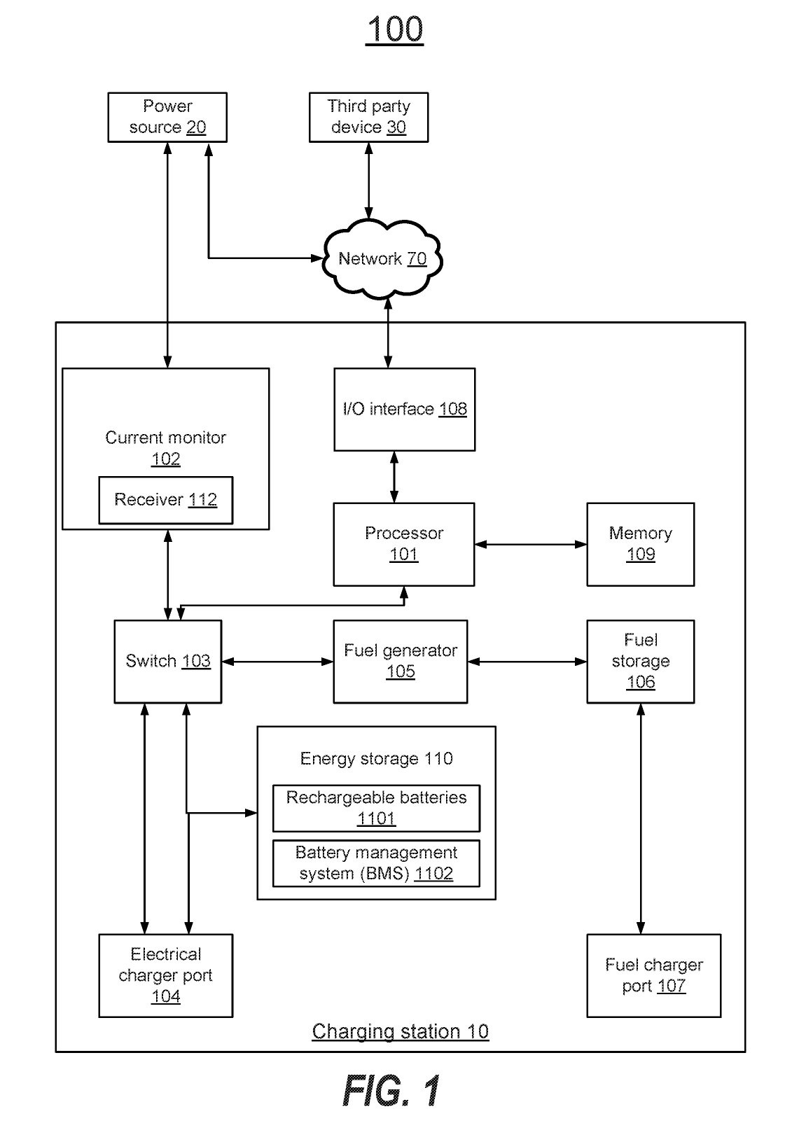

FIG. 1 is a block diagram illustrating a dual charging station system 100, consistent with exemplary embodiments of the present disclosure. System 100 may comprise a number of components and sub-components, some of which may be optional. However, it is not necessary that all of these components be shown in order to disclose an illustrative embodiment.

As illustrated in FIG. 1, system 100 may include a charging station 10, power source 20, and third party device 30. Charging station 10 and power source 20 may be connected directly. Charging station 10, power source 20, and third party device 30 may be connected via network 70.

Power source 20 may be a national or regional power grid, e.g., a traditional grid, a smart grid, and etc. Power source 20 may also be a renewable energy source, such as a solar energy source connect to solar panels, a wind energy source connect to wind turbines, a geothermal energy source, a tidal energy source, a wave energy source, and etc. Power source 20 may be configured to supply power to charging station 10. The supplied power may cover a range of voltages or amperes, sufficient to charge various EVs and support a fuel generator 105, which may in some embodiments be a hydrogen generator (i.e. electrolyzer system). Power source 20 may also communicate with charging station 10 to adjust the power supply level.

Third party device 30 may include a smart phone, a tablet, a personal computer, a server, a wearable device, such as a smart watch or Google Glass™, and/or complimentary components. Third party device 30 may be configured to connect to a network, such as a nationwide cellular network, a local wireless network (e.g., Bluetooth™ or WiFi), and/or a wired network. Third party device 30 may also be configured to access apps and websites of third parties, such as iTunes™, Google™, Facebook™, Yelp™, or other apps and websites associated with vehicle 10. Third party device 30 may store, share, and be associated with data and information, such as a profile of a vehicle (e.g., the year, make, model, and owner of the vehicle). In some embodiments, third party device 30 may communicate with charging station 10 and indicate a future visit to recharge a vehicle associated with third party device 30.

Charging station 10 may include a processor 101, a current monitor 102, a switch 103, an electrical charger port 104, e.g., an EV charger port, a fuel generator 105, a fuel storage 106, a fuel charger port 107, an I/O interface 108, a memory 109, and an energy storage 110. Current monitor 102 may be connected to switch 103. Switch 103 may connect to energy storage 110, EV charger port 104, processor 101, and fuel generator 105. Energy storage 110 may also connect to EV charger port 104. Processor 101 may also connect to I/O interface 108 and memory 109. Fuel generator 105 may connect to fuel storage 106. Fuel storage 106 may connect to fuel charger port 107.

Memory 109 may be non-transitory and computer-readable and may store instructions that, when executed by processor 101, cause one or more components of system 100 to perform one or more methods described in this disclosure. One or more of the components of charging station 10 may be optional. For example, processor 101 may directly connect to network 70, bypassing I/O interface 108. Therefore, it is not necessary that all of the above components be shown in order to disclose an illustrative embodiment. Processor 101 may be configured to receive signals and process the signals to determine a plurality of conditions of the operation of charging station 10 (e.g., operations of EV charger port 104 and fuel charger port 107).

I/O interface 108 may include connectors for wired communication, wireless transmitters and receivers, and/or wireless transceivers for wireless communications. The connectors, transmitters/receivers, or transceivers may be configured for two-way communication between processor 101 and various components of system 100. I/O interface 108 may send and receive operating signals to and from third party device 30. I/O interface 108 may send and receive the data between each of the devices via communication cables, wireless networks, or other communication mediums. For example, third party devices 30 may be configured to send and receive signals to I/O interface 108 via a network 70. The signals may include an indication, such as an appointment time, to charge an EV or fuel cell vehicle at charging station 10. Network 70 may be any type of wired or wireless network that may facilitate transmitting and receiving data. For example, network 70 may be a nationwide cellular network, a local wireless network (e.g., Bluetooth™ or WiFi), and/or a wired network.

Current monitor 102 may comprise a receiver 112 configured to receive power from power source 20. Receiver 112 may include various devices for receiving power from power source 20 and converting the received power to the right form for use by the downstream devices. For example, receiver 112 may include DC-DC, AC-DC, or DC-AC buck converter for converting high voltage to lower voltage. Current monitor 102 may be configured to monitor the received power. For example, if the incoming power is too high or too low, current monitor 102 may send a signal to processor 101, which may respond accordingly.

Energy storage 110 may comprise one or more rechargeable batteries 1101 and a battery management system (BMS) 1102. Rechargeable batteries 1101 may be configured to receive and store electric power from switch 103, to store energy when the electrical charger port 104 and/or the fuel charger port 107 are not in use, and/or deliver the stored electric power to EV charger port 104. BMS 1102 may be configured to monitor status of rechargeable batteries 1101 and communicate with processor 101 about the status.

Switch 103 may be configured to switch the received power among energy storage 110, EV charger port 104, and fuel generator 105. The condition for switching may be determined by processor 101. For example, when charging station 10 is open for business or during day time, processor 101 may switch the power from power source 20 to EV charger port 104, and may switch the power from power source 20 to fuel generator 105 when charging station 10 closes for business or during night time. For another example, when rechargeable batteries 1101 are fully charged, BMS 1102 may transmit the status to processor 101, which may switch the power from energy storage 110 to fuel generator 105. In some embodiments, more than one of energy storage 110, EV charger port 104, and fuel generator 105 may receive power from receiver 112. For example, EV charger port 104 and energy storage 110 may simultaneously receive power from receiver 112. For another example, all three of them may simultaneously receive power from receiver 112. The allocation of power and the proportion of allocated power may be determined by processor 101 based on conditions such as time, cost, efficiency, and the like.

Fuel generator 105 may be configured to generate fuel for fuel cell vehicles. In some embodiments, the generated fuel is hydrogen, and fuel generator 105 may be configured to generate the hydrogen through various electric-based methods. For example, fuel generator 105 may be configured to split water into oxygen and hydrogen through electrolysis. For another example, fuel generator 105 may be configured to split water by reacting sodium hydroxide, ferrosilicon, and water through a ferrosilicon method. In yet another example, fuel generator 105 may be an algae bioreactor configured to split water (known as photobiological water splitting). In addition, fuel generator 105 may be configured to split water under the facilitation of various agents including, for example, methanol or other organic solutions (known as chemically-assisted electrolysis), titanium dioxide or other photocatalysts (known as photocatalytic water splitting), enzyme (known as fermentative hydrogen production or enzymatic hydrogen generation), and the like. The generated hydrogen may be received by fuel storage 106, which may compress the hydrogen or process the hydrogen in another manner for delivery to fuel charger port 107. A fuel cell vehicle may replenish hydrogen from fuel charger port 107, and an EV may be charged at EV charger port 104.

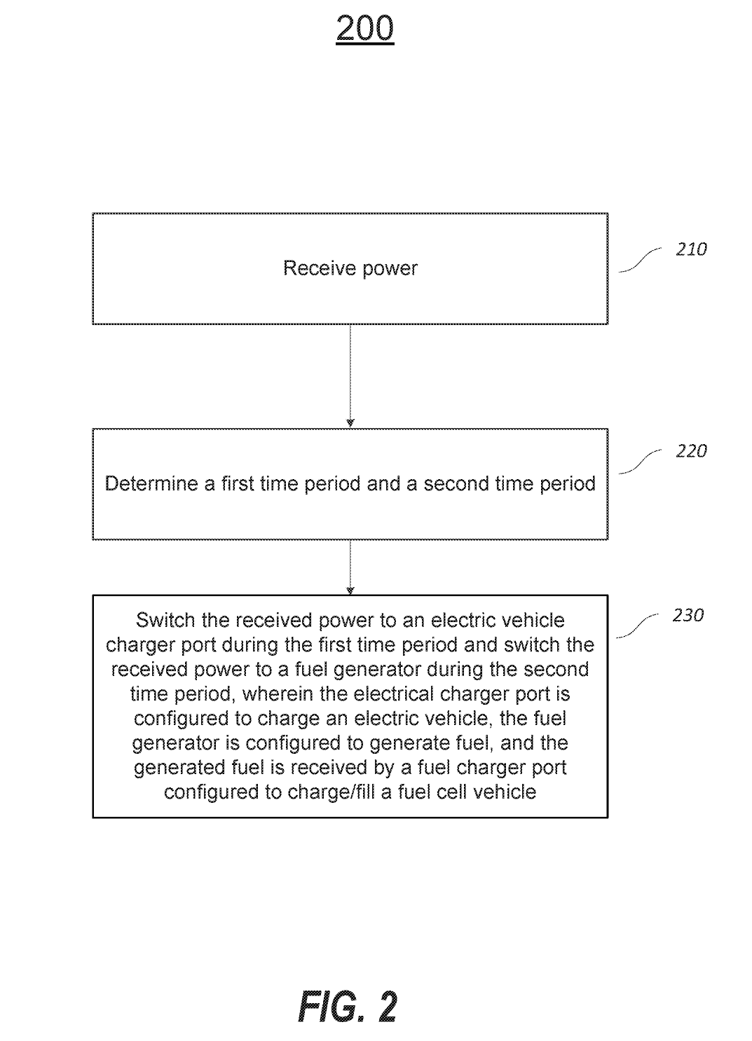

FIG. 2 is a flow diagram illustrating method 200 for dual charging, consistent with exemplary embodiments of the present disclosure. Method 200 may include a number of steps and sub-steps, some of which may be optional. The steps or sub-steps may also be rearranged in another order.

At step 210, one or more components of system 100 may receive power. For example, receiver 112 of current monitor 102 may receive the power from a power grid, from a renewable energy source, and etc.

At step 220, one or more components of system 100 may determine a first time period and a second time period. For example, processor 101 may determine day time as the first time period and night time as the second time period.

At step 230, one or more components of system 100 may switch the received power to an electric vehicle charger port during the first time period and switch the received power to a fuel generator during the second time period. The electric vehicle charger port is configured to charge an electric vehicle. The fuel generator is configured to generate fuel. The fuel can be delivered to a fuel charger port to charge/fill a fuel cell vehicle. For example, processor 101 may switch the received power to an electric vehicle charger port 104 at day time or business hour of a charging station, during which both EVs and fuel cell vehicles can be recharged. Processor 101 may switch the received power to a fuel generator 105 during night time or non-business hours of charging station 10. The fuel generator 105 may be configured to produce hydrogen, for example by using the received electrical power to split water into oxygen and hydrogen. The produced hydrogen may be received and stored at fuel storage 106, which then supplies the hydrogen to fuel charger port 107. Hydrogen may also be directly transferred from fuel generator 105 to fuel charger port 107. A fuel cell vehicle or a hybrid vehicle, such as an EV with a fuel cell-based range extender, may be refilled at fuel charger port 107, e.g., by receiving the hydrogen. The hydrogen may be compressed at any of the steps above.

In some embodiments, the received power from power source 20 may be constant throughout day and night. Therefore, during a time period when the EV charger port is not used, the received power may be utilized to produce hydrogen from an electrolyzer (that is, an example of fuel generator 105). The electrolyzer may be configured to work under the voltage and current range of the charger port. Thus, the charging station can provide dual energy recharge services at the same site. The disclosed systems and methods are cost and energy-efficient overall, since the charging station no longer needs to modulate the receiving power, and the grid or the power source can maintain the power supply at a constant level. The disclosed systems and methods can also reduce the fuel price, since hydrogen can now be produced at the charging station, and transporting cost for compressed hydrogen can be saved.

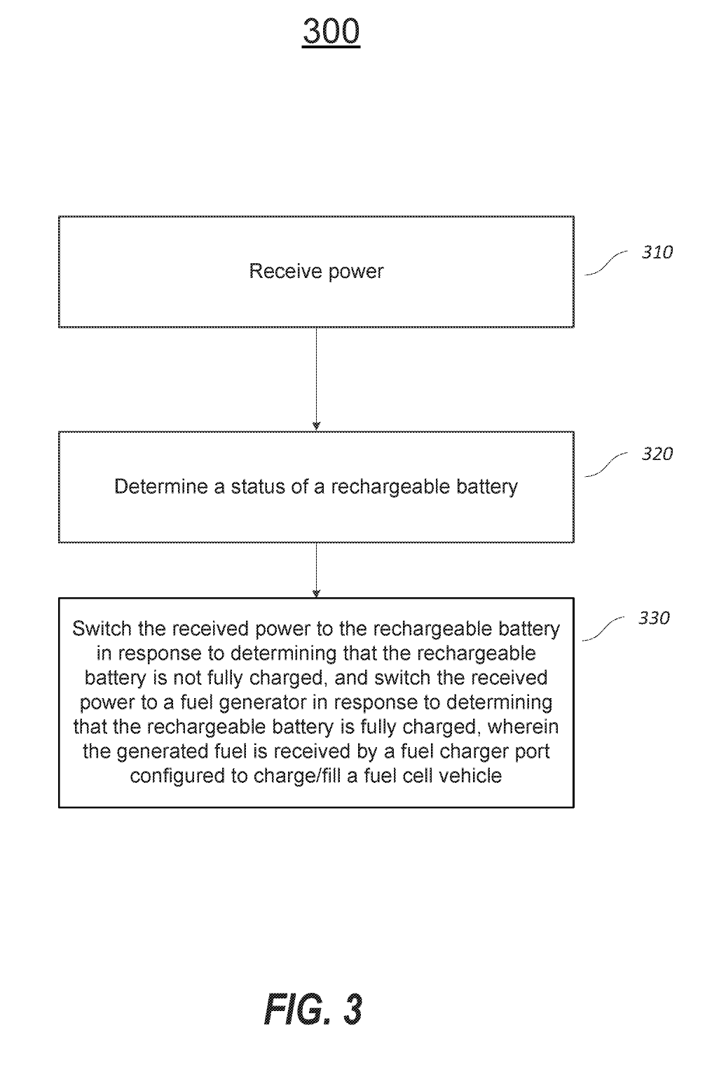

FIG. 3 is a flow diagram illustrating method 300 for dual charging, consistent with exemplary embodiments of the present disclosure. Method 300 may include a number of steps and sub-steps, some of which may be optional. The steps or sub-steps may also be rearranged in another order.

At step 310, one or more components of system 100 may receive power. For example, receiver 112 of current monitor 102 may receive the power from a power grid, from a renewable energy source, and etc.

At step 320, one or more components of system 100 may determine a status of a rechargeable battery. For example, BMS 1102 and/or processor 101 may determine a power level of one or more rechargeable batteries 1101.

At step 330, one or more components of system 100 may switch the received power to the rechargeable battery in response to determining that the rechargeable battery is not fully charged, and switch the received power to a fuel generator in response to determining that the rechargeable battery is fully charged. The generated fuel may be received by a fuel charger port configured to charge/fill a fuel cell vehicle. Alternatively, the condition for switching may be configured to a certain power level, a certain time, or etc.

In some embodiments when power source 20 is solar, wind, or another renewable energy source, power received by receiver 112 can be received by any EV charger port 104, rechargeable batteries 1101, and fuel generator 105 to achieve efficient energy utilization. For example, in some situations, the solar panel or wind turbine may work in continuation. That is, even when rechargeable batteries 1101 are fully charged, power source 20 may still continue to generate electricity, since a temporary brake may be impractical or costly to its operation. As described above, such power can be channeled to fuel generator 105, creating hydrogen to charge fuel cell vehicles. Thus, power source 20 can continue operating, and the generated power can be stored in various forms for future dispenses to various vehicles, achieving a high overall energy efficiency.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for dual charging stations. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A dual charging system, comprising:
a receiver configured to receive power;
an electrical charger port coupled to the receiver for charging a vehicle;
a rechargeable battery coupled to the receiver and the electrical charger port;
a fuel generator coupled to the receiver; and
a switch coupled to the receiver, the electrical charger port, rechargeable battery, and fuel generator, and configured to switch the received power from the receiver to at least one of the rechargeable battery, the fuel generator, or the electrical charger port.

2. The system of claim 1, wherein the switch is configured to switch the received power to the rechargeable battery in response to a determination that the rechargeable battery is not fully charged.

3. The system of claim 1, wherein the switch is configured to switch the received power to the fuel generator in response to a determination that the rechargeable battery is fully charged.

4. The system of claim 1, wherein the rechargeable battery is configured to store the received power and supply the stored power to the electric vehicle charger port.

5. The system of claim 1, wherein the fuel generator is configured to use electrical power to produce hydrogen.

6. The system of claim 5, further comprising a fuel storage coupled to the fuel generator to receive the produced hydrogen.

7. The system of claim 5, wherein the fuel generator comprises an electrolyzer.

8. A dual charging system, comprising:
a receiver configured to receive power;
a fuel generator coupled to the receiver;
an electrical charger port coupled to the receiver; and
a switch configured to switch the received power to the electrical charger port during a first time period and switch the received power to the fuel generator during a second time period.

9. The system of claim 8, further comprising a rechargeable battery coupled to the electrical charger port.

10. The system of claim 8, wherein the power is received from a renewable energy source.

11. The system of claim 8, further comprising a processor configured to determine the first time period and the second time period and coupled to the switch to control the switch.

12. The system of claim 8, wherein the fuel generator is configured to use electrical power to produce hydrogen.

13. The system of claim 12, further comprising a fuel storage coupled to the fuel generator to receive the produced hydrogen.

14. The system of claim 12, wherein the fuel generator comprises an electrolyzer.

15. A dual charging method, comprising:
receiving power at a receiver; and
switching the received power from the receiver to at least one of a rechargeable battery, a fuel generator, or an electrical charger port, wherein:
the electrical charger port couples to the receiver for charging a vehicle;
the rechargeable battery couples to the receiver and the electrical charger port;
the fuel generator couples to the receiver; and
the switch couples to the receiver, the electrical charger port, the rechargeable battery, and the fuel generator.

16. The method of claim 15, wherein switching the received power from the receiver to at least one of the rechargeable battery, the fuel generator, or the electrical charger port comprises switching the received power to the rechargeable battery in response to a determination that the rechargeable battery is not fully charged.

17. The method of claim 15, wherein switching the received power from the receiver to at least one of the rechargeable battery, the fuel generator, or the electrical charger port comprises switching the received power to the fuel generator in response to a determination that the rechargeable battery is fully charged.
